(19) United States
(12) Patent Application Publication
(10) Pub. No.: US 2015/0132616 A1
(43) Pub. Date: May 14, 2015

(54) METHOD AND DEVICE FOR TRIGGERING AT LEAST ONE SAFETY FUNCTION IN THE EVENT OF A STATE OF AN ELECTROCHEMICAL STORE THAT IS CRITICAL WITH REGARD TO SAFETY, AND ELECTROCHEMICAL ENERGY STORAGE SYSTEM

(71) Applicant: Robert Bosch GmbH, Stuttgart (DE)

(72) Inventors: Kathy Sahner, Mannheim (DE); Thomas Classen, Stuttgart (DE); Jens Grimminger, Leonberg (DE); Bernd Schumann, Rutsheim (DE); Frank Baumann, Mundelsheim (DE); Dirk Liemersdorf, Sachsenheim (DE)

(21) Appl. No.: 14/397,668

(22) PCT Filed: Mar. 11, 2013
(86) PCT No.: PCT/EP2013/054893

§ 371 Date: Oct. 29, 2014

(30) Foreign Application Priority Data
Apr. 30, 2012 (DE) 10 2012 207 152.0

(51) Int. Cl. H01M 10/42; H01M 10/48

(52) U.S. Cl. CPC H01M 10/4257; H01M 10/48; H01M 2010/4271
USPC 429/50; 429/61

(57) ABSTRACT

A method for triggering at least one safety function in the event of a safety-critical state of an electrochemical energy store includes: detecting the safety-critical state of the electrochemical energy store using a sensor signal which represents at least one detected state variable of the electrochemical energy store; generating a safety function signal based on the detected safety-critical state of the electrochemical energy store; and triggering the at least one safety function based on the safety function signal.

### BACKGROUND OF THE INVENTION

1. Field of the Invention

The present invention relates to a method for triggering at least one safety function in the event of a state of an electrochemical energy store that is critical with regard to safety, to a device for triggering at least one safety function in the event of a state of an electrochemical energy store that is critical with regard to safety, to an electrochemical storage system and to a corresponding computer program product.

2. Description of the Related Art

In recent years, lithium-ion batteries in particular have increasingly gained in importance as electrochemical energy stores. Aside from their use in portable devices such as laptops or mobile telephones for example, the focus of research and development activity is in particular on an application in electric vehicles. Depending on the design for hybrid vehicles, plug-in hybrid vehicles or electric vehicles without an additional engine, a capacity of current battery systems may reach for example values of approximately 1 to 10 kiloampere-hours, corresponding to a stored energy of approximately 3 to 40 kilowatt-hours.

### BRIEF SUMMARY OF THE INVENTION

Against this background, the present invention provides an improved method for triggering at least one safety function in the event of a state of an electrochemical energy store that is critical with regard to safety, an improved device for triggering at least one safety function in the event of a state of an electrochemical energy store that is critical with regard to safety, an improved electrochemical storage system and an improved computer program product.

A method for triggering at least one safety function in the event of a state of an electrochemical energy store that is critical with regard to safety comprises the following steps:

detecting the state of the electrochemical energy store that is critical with regard to safety by using a sensor signal, which represents at least one detected state variable of the electrochemical energy store; and
generating a safety function signal as a function of the detected state of the electrochemical energy store that is critical with regard to safety, the safety function signal being developed to trigger the at least one safety function.

The electrochemical energy store may be at least one galvanic or electrochemical cell, a battery cell or the like, in particular a secondary cell. The electrochemical energy store may be a so-called battery pack or the like, for an electric vehicle for example. The electrochemical energy store may have a plurality of battery cells or cells as subunits of the energy store, it being possible for the cells to form the electrical energy store. The electrochemical energy store may also have a single battery cell. A housing of the electrochemical energy store or of a single battery cell of the electrochemical energy store may hermetically separate or seal off an interior space of the battery cell from a surrounding area of the battery cell. The housing accommodates or is able to accommodate, for example, an electrochemical reaction device, the electrode modules and an electrolyte. A state of the electrochemical energy store that is critical with regard to safety may be connected to a malfunction of the electrochemical energy store. A state of the electrochemical energy store that is critical with regard to safety may result in uncontrolled overheating, an uncontrolled rise in pressure, fire, an explosion or the like. In the step of detecting, it is also possible to detect multiple states that are critical with regard to safety, that is, at least one state that is critical with regard to safety. If multiple states critical with regard to safety are detected, then, in the step of generating, the safety function signal may be generated as a function of the plurality of detected states that are critical with regard to safety. The multiple safety-critical states may be assigned to the same or to different state variables. The at least one state variable of the electrochemical energy store may be a pressure, a temperature, a concentration of a material, another chemical or physical variable etc. with respect to the electrochemical energy store. The sensor signal may have a value that represents a value of a state variable of the electrochemical energy store. The safety function signal may be output to at least one safety device for carrying out the at least one safety function. The safety function signal may be developed to bring about an execution of the at least one safety function with the aid of the at least one safety device. A safety function in this context may comprise an information measure or a countermeasure with respect to the safety-critical state of the electrochemical energy store.

According to specific embodiments of the present invention, it is possible in particular to initiate or trigger appropriate measures as a function of the degree of severity of the malfunction of an electrochemical energy store, e.g. a lithium-ion battery. In order to be able to differentiate between different degrees of malfunction, a multi-level warning is provided, for example. What is thus provided in particular is a safety system or a sensor system for electrochemical storage systems, for electric vehicles for example, which is developed to transmit a multi-level warning signal depending on the severity of the malfunction in particular to the immediate surroundings.

In the field of vehicles, for example, it is also possible to initiate or trigger driver protection measures in the event of a malfunction of an electrochemical energy store, e.g. a lithium-ion battery. In particular a safety system or a monitoring system for electrochemical storage systems, for example for electric vehicles, is thus also provided, which is developed in order to initiate protective and containment measures in the event of a malfunction or breakdown of the energy store with the aid of sensor technology, signal processing and actuator technology. A sensor signal of a detection system may thus be used, for example, in order to trigger driver protection systems, e.g. warning a driver via a signal light on the dashboard, and/or containment measures, e.g. the activation of an extinguishing function.

It is also possible in particular to initiate or trigger measures for protecting a wider surrounding area in the event of a malfunction of a lithium-ion battery. It must be noted that, for example, an electric vehicle having a defective battery also represents a danger to the wider immediate surroundings, i.e. to other road users etc., due to a latent danger of an explosion. For this reason, warning functions are also provided in particular for the surrounding area. In other words, a sensor-actor system for electrochemical storage systems, for example for electric vehicles, is also provided, which is developed to transmit warning signals to a surrounding area in the event of a breakdown of the energy store.

One advantage lies in the ability to increase an operational safety of electrochemical energy stores. This may be achieved by an adaptable warning function for users as well as for the surroundings and/or an activation of automatic protective measures. In order thus to limit the danger, for example, of a complete breakdown following a cell defect of the electrochemical energy store, a safety system or detection system may thus be created, which warns in a timely manner of a possible malfunction and is able to respond with countermeasures as early as possible, ideally at the first sign of an irregularity, for example clearly prior to overheating. Thus, a multi-level warning system is possible for example, which is able to differentiate between different degrees of a battery malfunction with respect to a user warning and/or surroundings warning. In order to reduce as much as possible a danger potential of a damaged battery for example, a sensor signal of a detection system may also be used in particular to trigger at least one protective system for users, e.g. for vehicle occupants.

According to one specific embodiment of the method, a value of the sensor signal may be compared in the step of detecting to at least one threshold value in order to detect the state of the electrochemical energy store that is critical with regard to safety. If the value of the sensor signal falls below or exceeds a threshold value, a safety-critical state of the electrochemical energy store may be detected. The value of the sensor signal may also be compared to a first threshold value and at least one additional threshold value. In this instance, it is possible also to detect at least one risk level of the safety-critical state of the electrochemical energy store as a function of a ratio of the value of the sensor signal to the first threshold value and to the at least one additional threshold value. In particular, it is possible to detect a first risk level of the safety-critical state of the electrochemical energy store in the event of a first ratio of the value of the sensor signal to the first threshold value and to the at least one additional threshold value. It is also possible to detect a second risk level of the safety-critical state of the electrochemical energy store in the event of a second ratio of the value of the sensor signal to the first threshold value and to the at least one additional threshold value. Such a specific embodiment offers the advantage of allowing for a distinction between different risk levels or degrees of severity of a malfunction. This allows for finely graduated safety functions depending on the detected degree of severity.

For this purpose, in the step of detecting, a first state of the electrochemical energy store that is critical with regard to safety may be detected if the sensor signal has a first value. Furthermore, in the step of detecting, a second safety-critical state of the electrochemical energy store may be detected if the sensor signal has a second value. For this purpose, the values of the sensor signal may represent a single state variable or different state variables of the electrochemical energy store. Furthermore, the first safety-critical state and the second safety-critical state of the electrochemical energy store may correspond to a first risk level and a second risk level of a common safety-critical state of the electrochemical energy store. Such a specific embodiment offers the advantage of allowing for a distinction between different risk levels or degrees of severity of a malfunction as well as between different malfunctions. In this manner, finely graduated safety functions may be found also for particular precisely detectable malfunction scenarios.

Furthermore, in the step of generating, a first safety function signal may be generated as a function of a first safety-critical state of the electrochemical energy store. For this purpose, the first safety function signal may be developed to trigger the at least one safety function. Furthermore, in the step of generating, a second safety function signal may be generated as a function of a second safety-critical state of the electrochemical energy store. For this purpose, the second safety function signal may be developed to trigger the at least one second safety function. In a function characteristic, first safety function may correspond to the second safety function or may differ from the second safety function. Such a specific embodiment offers the advantage that fitting, appropriate, adjusted and, if applicable, multi-level safety functions may be triggered for different malfunction scenarios of an electrochemical energy store.

According to one specific embodiment, a safety function signal may be generated in the step of generating, which is developed to trigger an output of at least one warning signal with respect to the detected safety-critical state of the electrochemical energy store as the at least one safety function. A warning signal may be perceptible for a user of the electrochemical energy store and/or for a wider surrounding area of the electrochemical energy store. The at least one warning signal may be output acoustically, optically or perceptible in another manner. Such a specific embodiment offers the advantage that precautionary measures, rescue measures and/or manually triggered protective measures or countermeasures may be effected and made possible by the warning signal. Damage prevention and/or damage limitation may thus be achieved. The warning signal may be additionally adjusted to the precise malfunction scenario.

In the step of generating, a safety function signal may be generated, which is developed to trigger an activation of at least one protective measure with respect to the detected safety-critical state of the electrochemical energy store as the at least one safety function. In this instance, the at least one protective measure may be initiated automatically in response to the safety function signal. The at least one protective measure may prevent damage and/or limit damage with respect to the safety-critical state. Such a specific embodiment offers the advantage that even automatically executable precautionary measures, rescue measures and/or countermeasures may be effected and made possible by the protective measure.

Additionally, it is possible to provide a step of detecting a concentration of an electrolyte of the electrochemical energy store outside of the electrochemical energy store as the at least one detected state variable. Furthermore, a step of generating the sensor signal as function of the concentration of the electrolyte outside of the electrochemical energy store may be provided. Such a specific embodiment offers the advantage that the detection of the external electrolyte concentration represents a suitable decision criterion, which appears reliably and in a timely manner in different cases of damage in different strengths and thus allows for a reliable distinction of risk levels or malfunctions.

A device for triggering at least one safety function in the event of a safety-critical state of an electrochemical energy store is developed to carry out the steps of an aforementioned method. The device may have suitable mechanisms that are developed to implement or carry out the steps of the method.

In the present case, a device may be understood as an electrical device which processes sensor signals and outputs control signals and/or data signals as a function of the latter. The device may include an interface developed as hardware and/or software. In a development as hardware, the interfaces may be part of a so-called system ASIC, for instance, which includes many different functions of the device. It is also possible, however, for the interfaces to be separate, integrated circuits or to be at least partially made up of discrete components. In a development as software, the interfaces may be software modules which are provided on a microcontroller in addition to other software modules, for example. An aforementioned method for triggering may be advantageously applied or used in combination with the device for triggering. An aforementioned method for triggering may also be advantageously carried out by using the device.

The present invention furthermore creates an electrochemical energy storage system having the following features:

at least one electrochemical energy store;
at least one sensor device for detecting at least one state variable of the electrochemical energy store and outputting a sensor signal that represents the detected state variable of the electrochemical energy store; and
an aforementioned device that is able to receive the sensor signal from the sensor device.

In combination with the electrochemical energy storage system, an aforementioned device may be applied or used advantageously in order to trigger at least one safety function in the event of a safety-critical state of an electrochemical energy store. The sensor device may operate on the basis of an optical, chemical, thermal and/or mechanical detection principle. A heat tonality or a temperature change, for example, may be detected on the basis of the thermal detection principle. The mechanical detection principle may be based, for example, on a pressure measurement, a force measurement or the like. The sensor device may have at least one sensor element, which is situated within or outside of the at least one electrochemical energy store. The sensor signal may be transmitted from the sensor device via a communication interface to the device for triggering. A communication interface may be implemented for example by an electrical line or a wireless transmission by radio, inductive coupling or the like.

Also advantageous is a computer program product having program code that is stored on a machine-readable carrier such as a semiconductor memory, a hard-disk memory or an optical memory, and is used to carry out the aforementioned method when the program is executed on a computer or a device.

### BRIEF DESCRIPTION OF THE DRAWINGS

FIG. 1 a schematic representation of an electrochemical energy storage system according to an exemplary embodiment of the present invention.

FIG. 2 a schematic representation of an electrochemical energy storage system according to an exemplary embodiment of the present invention.

FIG. 3 a flow chart of a method according to an exemplary embodiment of the present invention.

### DETAILED DESCRIPTION OF THE INVENTION

In the following description of preferred exemplary embodiments of the present invention, identical or similar reference numerals are used for similarly acting elements shown in the various figures, a repeated description of these elements being omitted.

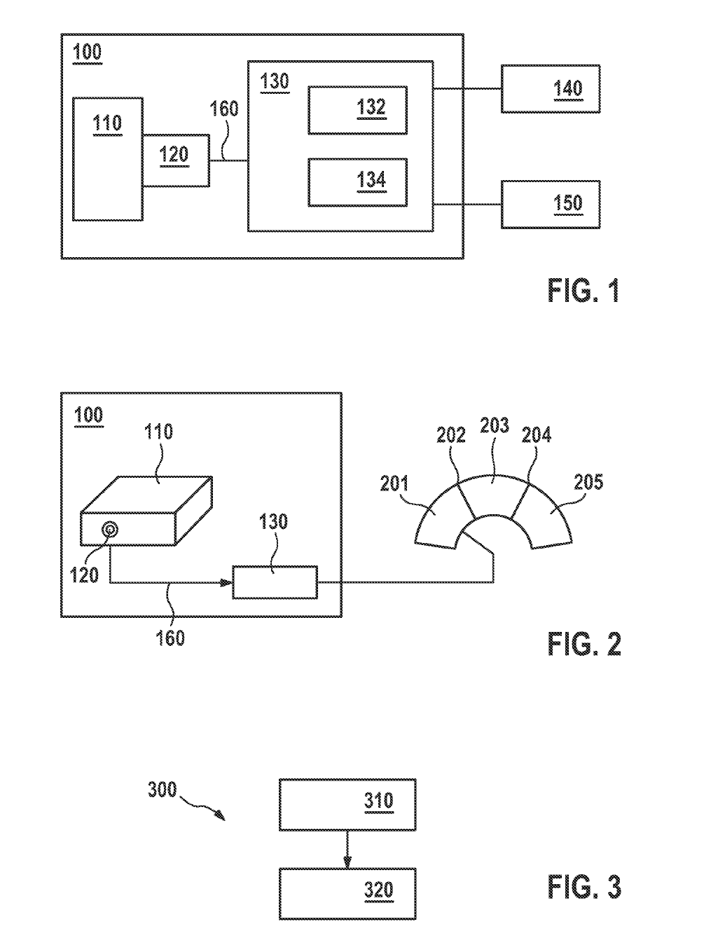

FIG. 1 shows a schematic representation of an electrochemical energy storage system according to an exemplary embodiment of the present invention. The figure shows an electrochemical energy storage system 100, which includes an electrochemical energy store 110, also called a secondary cell or battery cell, a sensor device 120 and a triggering device 130 having a detection device 132 and a generating device 134. A warning device 140 and an actuator device 150 are also shown. Electrochemical energy storage system 100 is installed or installable in an electric vehicle or a hybrid-electric vehicle for example. Electrochemical energy store 110 is in particular a lithium-ion cell or the like.

According to the exemplary embodiment of the present invention shown in FIG. 1, sensor device 120 is situated adjoining electrochemical energy store 110. Alternatively, according to another exemplary embodiment of the present invention, sensor device 120 may also be situated at a distance from and neighboring electrochemical energy store 110 or within a battery housing of electrochemical energy store 110. Sensor device 120 may also have a plurality of sensor elements, which may be situated adjoining electrochemical energy store 110, neighboring electrochemical energy store 110 and/or within a battery housing of electrochemical energy store 110. Sensor device 120 is developed to detect at least one state variable of electrochemical energy store 110. Sensor device 120 is also developed to output a sensor signal 160, which represents the detected state variable of the electrochemical energy store.

Triggering device 130 is developed to receive sensor signal 160, which represents the detected state variable of electrochemical energy store 110, from sensor device 120. For this purpose, triggering device 130 is able to receive sensor signal 160 from sensor device 120 via a communications interface, for example via an electrical line or a wireless transmission by radio, inductive coupling or the like. Triggering device 130 is provided for triggering at least one safety function in the event of a state of the electrochemical energy store 110 that is critical with regard to safety. Triggering device 130 is for example part of a battery management system (BMS) and has for example a functionality of an evaluation unit or evaluation circuit (sensor control unit, SCU).

Detection device 132 of triggering device 130 is developed to detect a safety-critical state of electrochemical energy store 110 by using sensor signal 160. Generating device 134 of triggering device 130 is developed to generate a safety function signal as a function of the detected safety-critical state of electrochemical energy store 110. For this purpose, the safety function signal is developed to trigger the at least one safety function. In particular, the safety function signal is developed in order to trigger the at least one safety function by using warning device 140 and/or actuator device 150.

Triggering device 130 is developed to output the safety function signal to warning device 140 and/or actuator device 150. According to the exemplary embodiment of the present invention shown in FIG. 1, warning device 140 and actuator device 150 are shown as electrically connected to triggering device 130 or electrochemical energy storage system 100. Alternatively, according to another exemplary embodiment of the present invention, it is also possible merely to situate or provide either warning device 140 or actuator device 150.

Warning device 140 is developed to generate and/or output, as the at least one safety function, at least one acoustic, optical and/or other perceptible warning signal for warning a user and/or a surrounding area of the electrochemical energy storage system 100 of the detected safety-critical state of electrochemical energy storage system 100 in response to and based on the safety function signal output by triggering device 130. Warning device 140 has a display, a loudspeaker, a warning light and/or a radio transmission device, for example.

Actuator device 150 is developed to activate, as the at least one safety function responding to and based on the safety function signal output by triggering device 130, at least one protective measure for protecting a user and/or a surrounding area of electrochemical energy storage system 100 against possible consequences of the detected safety-critical state of electrochemical energy store 100. Actuator device 150 includes for example a device for initiating a battery emergency shutdown, a device for activating safety systems such as e.g. extinguishing and cooling functions for electrochemical energy store 100, etc.

FIG. 2 shows a schematic representation of an electrochemical energy storage system according to an exemplary embodiment of the present invention. The figure shows an electrochemical energy storage system 100, which has an electrochemical energy store 110, a sensor device 120 and a triggering device 130. Electrochemical energy storage system 100 may be the electrochemical energy storage system from FIG. 1. Only the detection device and the generating device of triggering device 130 are not shown explicitly in FIG. 2. FIG. 2 furthermore shows in a symbolic manner a non-defective state 201 of electrochemical energy store 110 or one that is not critical with regard to safety, a first threshold value 202 or a first threshold, a first safety-critical state 203 of electrochemical energy store 110, another threshold value 204 or another threshold and another safety-critical state 205 of electrochemical energy store 110.

The state 201 of electrochemical energy store 110 that is not critical with regard to safety may obtain if on the part of of triggering device 130 no defect of electrochemical energy store 110 is detectable on the basis of sensor signal 160 from sensor device 120.

First threshold value 202 represents a boundary between state 201 that is not critical with regard to safety and safety-critical state 203 of electrochemical energy store 110. First threshold value 202 may be utilized by triggering device 130 to detect whether there exists at all a safety-critical state of electrochemical energy store 110.

First safety-critical state 203 of electrochemical energy store 110 may represent a low first risk level of a defect of electrochemical energy store 110. First safety-critical state 203 or the first risk level of a defect of electrochemical energy store 110 may be associated with a low first need for action for triggering at least one first safety function.

Additional threshold value 204 represents a boundary between the first safety-critical state 203 and the additional safety-critical state 205 of electrochemical energy store 110. Additional threshold value 204 may be utilized by triggering device 130 to detect whether there exists first safety-critical state 203 or additional safety-critical state 205 of electrochemical energy store 110.

Additional safety-critical state 205 of electrochemical energy store 110 may represent a high additional risk level of a defect of electrochemical energy store 110. Additional safety-critical state 205 or the additional risk level of a defect of electrochemical energy store 110 may be associated with a great additional need for action for triggering at least one additional safety function.

According to another exemplary embodiment of the present invention, a number of threshold value values and levels of safety-critical states may also deviate from the number represented in FIG. 2.

FIG. 3 shows a flow chart of a method 300 for triggering at least one safety function in the event of a safety-critical state of an electrochemical energy store, in accordance with one exemplary embodiment of the present invention. Method 300 may be executed advantageously in combination with a device for triggering or an electrochemical energy storage system from one of FIGS. 1 through 2. Method 300 includes a step of detecting 310 the safety-critical state of the electrochemical energy store using a sensor signal that represents at least one detected state variable of the electrochemical energy store. Method 300 furthermore includes a step of generating 310 a safety function signal as a function of the detected safety-critical state of the electrochemical energy store. For this purpose, the safety function signal is developed to trigger the at least one safety function.

In the following, various exemplary embodiments of the present invention are explained on the basis of malfunction scenarios or safety-critical states of an electrochemical energy store with reference to FIGS. 1 through 3.

According to one exemplary embodiment of the present invention, device 130 or method 300 for triggering at least one safety function in the event of a safety-critical state of electrochemical energy store 110 is able to initiate appropriate measures as a function of the degree of severity of a malfunction of a lithium-ion battery, for example. The triggering device or device 130 may thus be a safety system for lithium-ion batteries, for example, or may be a part of the same. In the case of a lithium-ion battery as electrochemical energy store 110, in particular for an electric vehicle, it is possible to distinguish several damage scenarios, which may require different reactions on the part of a user.

In a first exemplary case of damage, only a slight defect, e.g. a hairline crack in a battery cell, is observed. The defect results in a moderate outgassing of cell components, e.g. electrolyte, which may accelerate the aging of the battery cell and result in total failure over the long term. The earlier this case of damage can be reliably detected, the more moderate will be the countermeasures that must be initiated, for example an exchange of the defective module in regular maintenance. In a second exemplary case of damage, by contrast, battery cells open in the event of a malfunction, as a result of which larger quantities of cell substances may be outgassed. Such a massive defect normally occurs shortly prior to a complete breakdown and in the extreme case an explosion of the battery in a chain reaction and requires the quickest possible intervention into the operation and a controlled shutdown of the battery or electrochemical energy store 110. A further gradation especially of the first case of damage, e.g. according to the extent of the leakage, is also possible. Since the cases of damage may occur independently of one another, i.e. not every breakdown follows upon a small leakage, it is advantageous to distinguish both cases in the safety-related system, i.e. by the triggering device or device 130. Using device 130 or method 300 according to exemplary embodiments of the present invention, affected persons may be informed, not just about a defect, but also about the degree of risk, and are able to act accordingly. That is to say, in the event of a small leak, it is not necessary to leave the vehicle in flight-like manner, but rather a workshop may be visited and the battery pack or electrochemical energy store 110 may be serviced.

The precondition for this is the monitoring of a suitable decision criterion, which occurs reliable and sufficiently early in all cases of damage in varying intensity and thus allows for a differentiation. A possible decision criterion is the state variable of the concentration of electrolyte outside of the battery cells of electrochemical energy store 110. Estimates on standard battery packs for electric vehicles for the first case of damage, e.g. a small leak in electrochemical energy store 110, should lead one to expect for example an electrolyte concentration of a few 100 ppm, while the concentration in the case of a cell opening of a larger extent may be higher by up to two orders of magnitude. Both cases may be clearly distinguished via sensor device 120 in the form of a chemical sensor using a suitable characteristic curve. To implement sensor device 120, a chemical sensor element having a defined sensitivity for the battery electrolyte in the battery pack or in electrochemical energy store 110 may be integrated. This may be a sensor having a continuous characteristic curve, e.g. on the basis of an optical detection principle. Measuring signal or sensor signal 160 may be detected in particular permanently by triggering device 130 via a separate evaluation circuit (SCU) or directly by battery management system (BMS) and compared to stored threshold values, e.g. first threshold value 202 and/or second threshold value 204. Depending on the result of the comparison, the currently prevailing state is detected or evaluated as a case of a defect or a safety-critical state of electrochemical energy store 110. Based on the safety function signal generated by triggering device 130 or method 300, a battery user may be informed by a warning signal about the safety-critical state via an appropriate display, e.g. visually on the dashboard, acoustically or the like.

According to another exemplary embodiment of the present invention, device 130 or method 300 for triggering at least one safety function in the event of a safety-critical state of electrochemical energy store 110 is able to initiate driver protection measures in the event of a malfunction of a lithium-ion battery or the like. Via a suitable signal processing system in the form of device 130, sensor device 120 may be connected directly to at least one actuator device 150 for protective measures or actuator measures, which are able to protect occupants in addition or alternatively to a pure warning or information, e.g. an indicator display on the dashboard. Such a warning system on the basis of device 130 or method 300 may in particular also function autonomously, i.e. without a direct requirement for action on the part of the driver. Based on the safety function signal generated by triggering device 130 or method 300, at least one safety function may also be triggered when vehicle occupants for example underestimate the danger, in particular since explosions frequently occur without detectable outer damage or with a great time delay, or the driver himself is not able to take countermeasures due to a state of shock, unconsciousness or the like.

Device 130 and method 300, respectively, are based on a safety system made up of sensor device 120 and triggering device 130, which are developed to detect an imminent breakdown of electrochemical energy store 110. If the safety system detects a case of imminent danger, at least one protective measure is triggered via the safety function signal, which is suitable for protecting the driver and passengers and thus for reducing the risk potential. The protective measures may include an activation of a visual and/or acoustic warning function, e.g. verbal instructions with recommendations for action for vehicle occupants, measures for facilitating rescue measures, e.g. automatic unlocking of the doors, switching on interior lighting, decoupling the passenger cabin from the battery tract, e.g. switching off the supply air that is possibly chemically contaminated, initiating the battery emergency shutoff, activating additional safety systems, e.g. extinguishing and cooling function, activating an emergency call function, e.g. placing an emergency call via Bluetooth, wireless Internet etc.

According to yet another exemplary embodiment of the present invention, device 130 or method 300 for triggering at least one safety function in the event of a safety-critical state of electrochemical energy store 110 is able to trigger or effect for example an initiation of measures for protecting the surroundings in the event of a malfunction of a lithium-ion battery or the like. It is thus possible to create a safety system for electrochemical energy stores 110, in particular lithium-ion batteries for electric vehicles and the like. The safety system is able to increase not only the safety of the immediate users or vehicle occupants, but also the safety in the surrounding area. In the possible damage scenario of an explosion, electrochemical energy store 110 presents a source of danger for the surrounding area as well, which cannot always be immediately recognized as such from outside. Cases of damage are known, in which an explosion occurs without detectable external damage or after a great time delay following the shutdown of the battery. Device 130 or method 300 are therefore advantageous as they offer the possibility of outputting warning signals to the immediate surroundings in the event of damage. This warning function in particular may also function autonomously, i.e. without requiring an action of the driver/user. Based on the safety function signal generated by triggering device 130 or method 300, it is thus possible to trigger a warning for the surrounding area even when the vehicle has already been parked and the occupants have left the vehicle or the driver himself is not able to warn against the danger due to a state of shock, unconsciousness or the like.

Device 130 or method 300 are based on a safety system made up of sensor device 120 and triggering device 130, which are developed to detect an imminent breakdown of electrochemical energy store 110. If the safety system detects a case of imminent danger, at least one safety function or at least one warning signal is triggered via the safety function signal, which is suitable for informing the proximate and/or greater surrounding area about the danger emanating from electrochemical energy store 110. This may be implemented directly without intervention of the driver for example via a suitable integration of electronic functions in the battery management system (BMS). The possible safety functions or warning signals include in particular an activation of a visual warning function, e.g. activating the emergency flashers, an activation of an acoustic warning function, e.g. a horn, an activation of functions for safely parking the vehicle, e.g. by a corresponding request to the driver, reducing the speed etc.

The exemplary embodiments described and shown in the figures have been selected merely as examples. Different exemplary embodiments are combinable with one another, either completely or with regard to individual features. An exemplary embodiment may also be supplemented by features from another exemplary embodiment. Furthermore, method steps according to the present invention may be carried out repeatedly and also performed in a sequence other than the one described.

1-10. (canceled)

11. A method for triggering at least one safety function in the event of at least one safety-critical state of an electrochemical energy store, comprising:
detecting the at least one safety-critical state of the electrochemical energy store based on a sensor signal which represents at least one detected state variable of the electrochemical energy store;
generating at least one safety function signal as a function of the at least one detected safety-critical state of the electrochemical energy store; and
triggering the at least one safety function based on the at least one safety function signal.

12. The method as recited in claim 11, wherein in the step of detecting, a value of the sensor signal is compared to at least one threshold value in order to detect the safety-critical state of the electrochemical energy store.

13. The method as recited in claim 11, wherein in the step of detecting, a first safety-critical state of the electrochemical energy store is detected if the sensor signal has a first value, and a second safety-critical state of the electrochemical energy store is detected if the sensor signal has a second value.

14. The method as recited in claim 13, wherein in the step of generating, a first safety function signal is generated as a function of the first safety-critical state of the electrochemical energy store, the first safety function signal triggering the at least one first safety function, and a second safety function signal is generated as a function of the second safety-critical state of the electrochemical energy store, the second safety function signal triggering the at least one second safety function.

15. The method as recited in claim 12, wherein the at least one safety function signal triggers an output of at least one warning signal with respect to the detected safety-critical state of the electrochemical energy store as the at least one safety function.

16. The method as recited in claim 12, wherein the at least one safety function signal triggers an activation of at least one protective measure with respect to the detected safety-critical state of the electrochemical energy store as the at least one safety function.

17. The method as recited in claim 12, further comprising:
detecting a concentration of a selected electrolyte outside of the electrochemical energy store as the at least one detected state variable, wherein the selected electrolyte is also contained in the electrochemical energy store.

18. A device for triggering at least one safety function in the event of a safety-critical state of an electrochemical energy store, comprising:
at least one sensor device for detecting at least one state variable of the electrochemical energy store and outputting a sensor signal which represents the at least one detected state variable of the electrochemical energy store; and
a control unit for (i) detecting the safety-critical state of the electrochemical energy store based on the sensor signal, (ii) generating at least one safety function signal as a function of the detected safety-critical state of the electrochemical energy store, and (iii) triggering the at least one safety function based on the at least one safety function signal.

19. A non-transitory computer-readable data storage medium storing a computer program having program codes which, when executed on a computer, perform a method for triggering at least one safety function in the event of at least one safety-critical state of an electrochemical energy store, the method comprising:
detecting the at least one safety-critical state of the electrochemical energy store based on a sensor signal which represents at least one detected state variable of the electrochemical energy store;
generating at least one safety function signal as a function of the at least one detected safety-critical state of the electrochemical energy store; and
triggering the at least one safety function based on the at least one safety function signal.
